(19) United States
(12) Patent Application Publication
(10) Pub. No.: US 2026/0167763 A1
(43) Pub. Date: Jun. 18, 2026

(54) MANUFACTURING METHOD AND MANUFACTURING SYSTEM FOR EPOXY RESIN MONOMER

(71) Applicant: INDUSTRIAL TECHNOLOGY RESEARCH INSTITUTE, Hsinchu (TW)

(72) Inventors: Wei WANG, Hsinchu City (TW); Chih-Lung CHIN, Hsinchu City (TW); Chao-Wu LIAW, Taoyuan City (TW)

(73) Assignee: INDUSTRIAL TECHNOLOGY RESEARCH INSTITUTE, Hsinchu (TW)

(21) Appl. No.: 19/255,163

(22) Filed: Jun. 30, 2025

(30) Foreign Application Priority Data
Dec. 18, 2024 (TW) 113149363

(51) Int. Cl. C08G 59/12; B01J 19/00; B01J 19/18; C08G 59/02

(52) U.S. Cl. CPC C08G 59/12; B01J 19/0053; B01J 19/0093; B01J 19/1818; C08G 59/022; B01J 2208/00079; B01J 2208/00088; B01J 2208/00761

(57) ABSTRACT

A manufacturing method of epoxy resin monomer includes: mixing a reactant solution and a first catalyst solution to obtain a first intermediate solution; adding a second catalyst solution to the first intermediate solution to obtain a second intermediate solution; and adding an alkali compound solution to the second intermediate solution to obtain the epoxy resin monomer. The reactant solution includes a diphenol compound and epichlorohydrin.

### CROSS REFERENCE TO RELATED APPLICATIONS

This application claims priority of Taiwan Patent Application No. 113149363, filed on Dec. 18, 2024, the entirety of which is incorporated by reference herein.

### TECHNICAL FIELD

The present invention relates to a method and a system for manufacturing a resin monomer, and, in particular, it relates to a method and a system for manufacturing an epoxy resin monomer.

### BACKGROUND

Epoxy resin (EP resin), also known as artificial resin, synthetic resin, and resin glue, is a polymer compound containing two or more epoxy groups in its molecule. Epoxy resin can form a thermosetting three-dimensional network structure when it reacts with a curing agent. Epoxy resin is a very important thermosetting plastic and usually has high corrosion resistance and high chemical resistance, and thus it is widely used in adhesives, coatings, bonding agents, electronic product packaging, printed circuit boards, aviation, aerospace, the military industry, and other fields.

Properties of epoxy resin monomers are affected by their molecular weight and epoxy equivalent weight (EEW, which represents the number of grams of epoxy resin required to produce one mole of epoxy groups). For example, as the epoxy equivalent weight of an epoxy resin monomer decreases, the viscosity of the epoxy resin monomer decreases, oligomers formed during manufacturing decrease, and the glass transition temperature increases. Conversely, as the molecular weight of the epoxy resin monomer increases, the viscosity of the epoxy resin monomer increases and the rigidity of the cured product formed from the epoxy resin monomer increases.

In existing technology, bisphenol A (BPA) and epichlorohydrin (ECH) are commonly used to produce epoxy resin monomers. However, there remains a need for a manufacturing method and system for epoxy resin monomers that can enhance the reaction rate and product purity while reducing the consumption of epichlorohydrin.

### SUMMARY

An embodiment of the present disclosure provides a method for forming an epoxy resin monomer. The method for forming an epoxy resin monomer in the present disclosure comprises: mixing a reactant solution and a first catalyst solution to obtain a first intermediate solution; adding a second catalyst solution to the first intermediate solution to obtain a second intermediate solution; and adding an alkaline compound solution to the second intermediate solution to obtain the epoxy resin monomer. The reactant solution comprises diphenol compound and epichlorohydrin.

An embodiment of the present disclosure provides a system for manufacturing an epoxy resin monomer. The system for manufacturing an epoxy resin monomer comprises a first micro-reactor, a second micro-reactor, and a tubular reactor. The first micro-reactor and the tubular reactor are in fluid communication with the second micro-reactor. The system for manufacturing an epoxy resin monomer disclosed herein also comprises a first reactant tank, a second reactant tank, a third reactant tank, and a fourth reactant tank. The first reactant tank and the second reactant tank are in fluid communication with the first micro-reactor via a first delivery unit and a second delivery unit, respectively. The third reactant tank is in fluid communication with the second micro-reactor via a third delivery unit. The fourth reactant tank is in fluid communication with the tubular reactor via a fourth delivery unit.

### BRIEF DESCRIPTION OF THE DRAWINGS

The present invention can be more fully understood by reading the subsequent detailed description and examples with references made to the accompanying drawings, wherein:

FIG. 1 shows a flow chart of a method for manufacturing an epoxy resin monomer according to an embodiment of the present disclosure;

FIG. 2 shows a schematic of a system for manufacturing the epoxy resin monomer according to an embodiment of the present disclosure;

FIG. 3A shows a schematic of a first micro-reactor in the system for manufacturing the epoxy resin monomer according to an embodiment of the present disclosure;

FIG. 3B shows a partially enlarged schematic of the first micro-reactor in the system for manufacturing the epoxy resin monomer according to an embodiment of the present disclosure;

FIG. 4A shows a schematic of a second micro-reactor in the system for manufacturing the epoxy resin monomer according to an embodiment of the present disclosure;

FIG. 4B shows a partially enlarged schematic of the second micro-reactor in the system for manufacturing the epoxy resin monomer according to an embodiment of the present disclosure;

FIG. 5 shows a schematic of a tubular reactor in the system for manufacturing the epoxy resin monomer according to an embodiment of the present disclosure;

FIG. 6 shows a graph of the relationship between the epoxy equivalent weight and the epichlorohydrin equivalent/the diphenol equivalent of the epoxy resin monomer manufactured by the method according to an embodiment of the present disclosure; and

FIG. 7 shows a graph of the relationship between a conversion rate of bisphenol A and a reaction time in the method for manufacturing the epoxy resin monomer according to an embodiment of the present disclosure.

### DETAILED DESCRIPTION

It will be further understood that when “including” and/or “comprising” are used in this specification, they particularly refer to the existence of the described characteristic features, integers, steps, operations, elements, components, and/or groups thereof, but do not exclude the existence or addition of one or more other characteristic features, integers, steps, operations, elements, components, and/or groups thereof. When the singular forms “a” and “an” are used in this specification, it is intended to include the plural forms as well, unless the context clearly indicates otherwise.

It will be understood that although the terms “first”, “second”, and the like, may be used herein to describe various elements, components, regions, layers and/or portions, these elements, components, regions, layers and/or portions should not be limited by these terms. These terms are only used to distinguish one element, component, region, layer or portion from another element, component, region, layer or portion.

It will be understood that the methods described herein include multiple steps and that additional steps may be provided before, during and/or after the multiple steps described. Some of the steps described may be replaced or deleted in different embodiments. Although some embodiments discussed are performed by steps in a particular order, the steps may still be performed in another logical order.

“a to b” or “a-b” used herein to express a specific numerical range is defined as “≥a and ≤b”.

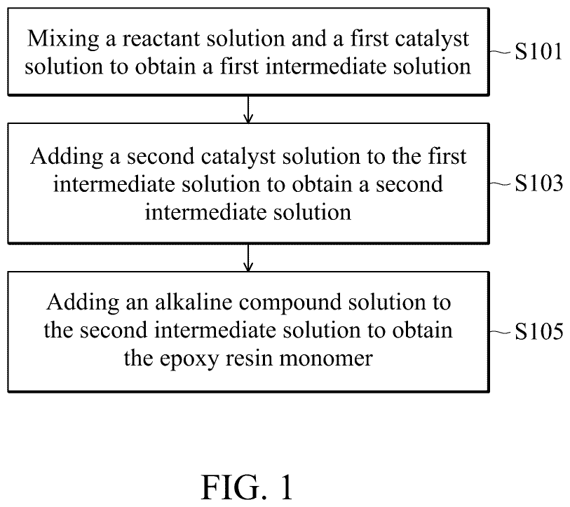

One aspect of the present disclosure provides a method for manufacturing an epoxy resin monomer. FIG. 1 shows a flow chart of a method for manufacturing an epoxy resin monomer according to an embodiment of the present disclosure. As shown in FIG. 1, the method for manufacturing the epoxy resin monomer according to the embodiment of the present disclosure includes: a step S101 of mixing a reactant solution and a first catalyst solution to obtain a first intermediate solution, a step S103 of adding a second catalyst solution to the first intermediate solution to obtain a second intermediate solution, and a step S105 of adding an alkaline compound solution to the second intermediate solution to obtain the epoxy resin monomer.

The reactant solution in the step S101 includes a diphenol compound and epichlorohydrin. In some embodiments, the diphenol compound may include bisphenol A, bisphenol F, bisphenol S, or a combination thereof. In some embodiments, the molar equivalent ratio of the diphenol compound to the epichlorohydrin may be 1:4.7 to 1:6.7.

The first catalyst solution in the step S101 includes a first catalyst and epichlorohydrin. In some embodiments, the weight ratio of the diphenol compound in the reactant solution to the first catalyst may be 90:5 to 98:1, and the weight ratio of the epichlorohydrin in the reactant solution to the epichlorohydrin in the first catalyst solution may be 90:5 to 98:1. The weight ratio within the above range may fully dissolve the diphenol compound in the reactant solution, and the concentration of the first catalyst solution meets the requirements. In some embodiments, the first catalyst may include a tertiary amine compound. In some embodiments, the first catalyst may be a liquid catalyst. Examples of the tertiary amine compound may include, but are not limited to, triethylamine, tripropylamine, tributylamine, or a combination thereof. In some embodiments, the tertiary amine compound may include triethylamine. The first catalyst including triethylamine may avoid the formation of oligomers during the manufacturing of the epoxy resin monomer and increase the purity of the epoxy resin monomer.

In the step S101, a reactant solution and a first catalyst solution undergo a first reaction process to obtain a first intermediate solution. In some embodiments, the first reaction process includes a first reaction temperature of 50° C. to 100° C. and a first reaction time of 1 hour to 1.5 hours. In some embodiments, the first reaction temperature may be 50° C. to 90° C., 50° C. to 80° C., 50° C. to 70° C., 55° C. to 65° C., or 60° C. The epoxy equivalent weight of the epoxy resin monomer formed by the method for manufacturing the epoxy resin monomer in the present disclosure may be adjusted by modifying the first reaction temperature in the first reaction process. For example, when the first reaction temperature is within the above temperature range, the epoxy resin monomer formed by the method for manufacturing the epoxy resin monomer in the present disclosure may have an epoxy equivalent weight of 200 g/mol or less, but the present disclosure is not limited thereto. In some embodiments, the epoxy equivalent weight of the epoxy resin monomer formed by the method for manufacturing the epoxy resin monomer in the present disclosure may be increased by raising the first reaction temperature in the first reaction process.

The second catalyst solution in the step S103 includes a second catalyst and epichlorohydrin. In some embodiments, the weight ratio of the diphenol compound in the reactant solution to the second catalyst may be 90:5 to 98:1, and the weight ratio of the epichlorohydrin in the reactant solution to the epichlorohydrin in the second catalyst solution may be 90:5 to 98:1. The weight ratio within the above range may fully dissolve the diphenol compound in the reactant solution, and the concentration of the second catalyst solution meets the requirements. Dividing the catalyst into two portions for addition helps reduce byproducts during the reaction between the diphenol compound and the epichlorohydrin. In some embodiments, the molar equivalent ratio of the epichlorohydrin in the reactant solution, the first catalyst solution, and the second catalyst solution to the diphenol compound is 7:1 to 5:1. The above equivalent ratio may fully dissolve the diphenol compound. In other embodiments, the molar equivalent ratio of the epichlorohydrin in the reactant solution, the first catalyst solution, and the second catalyst solution to the diphenol compound is 9:1 to 3:1, 8:1 to 4:1, or 7:1 to 5:1. In some embodiments, the second catalyst may include a tertiary amine compound. In some embodiments, the second catalyst may be a liquid catalyst. Examples of the tertiary amine compound may include, but are not limited to, triethylamine, tripropylamine, tributylamine, or a combination thereof. In some embodiments, the tertiary amine compound may include triethylamine. In some embodiments, the first catalyst and the second catalyst may be the same compound. The second catalyst including triethylamine may avoid the formation of oligomers during the manufacturing of the epoxy resin monomer and increase the purity of the epoxy resin monomer.

In the step S103, the second catalyst solution and the first intermediate solution obtained in the step S101 undergo a second reaction process to obtain a second intermediate solution. In some embodiments, the second reaction process includes a second reaction temperature of 50° C. to 100° C. and a second reaction time of 1 hour to 1.5 hours. In some embodiments, the second reaction temperature may be 50° C. to 90° C., 50° C. to 80° C., 50° C. to 70° C., 55° C. to 65° C., or 60° C. The epoxy equivalent weight of the epoxy resin monomer formed by the method for manufacturing the epoxy resin monomer in the present disclosure may be adjusted by modifying the second reaction temperature in the second reaction process. For example, when the second reaction temperature is within the above temperature range, the epoxy resin monomer formed by the method for manufacturing the epoxy resin monomer in the present disclosure may have an epoxy equivalent weight of 200 g/mol or less, but the present disclosure is not limited thereto. In some embodiments, the epoxy equivalent weight of the epoxy resin monomer formed by the method for manufacturing the epoxy resin monomer in the present disclosure may be increased by raising the second reaction temperature in the second reaction process.

The alkaline compound solution in the step S105 includes an alkaline compound and a solvent. The solvent may be selected as long as it can dissolve the alkaline compound and does not affect the reaction, and examples may include water, but the present disclosure is not limited thereto. In some embodiments, the alkaline compound may include sodium hydroxide, potassium hydroxide, sodium carbonate, potassium carbonate, or a combination thereof. In some embodiments, the concentration of the alkaline compound in the alkaline compound solution may be 10 wt % to 20 wt %. If the concentration of the alkaline compound in the alkaline compound solution is too high (for example, higher than 20 wt %), it will readily lead to the precipitation of solids (reaction byproduct, such as sodium chloride), and if the concentration is too low (for example, lower than 10 wt %), the reaction may be too slow, failing to meet the desired requirements.

In the step S105, the alkaline compound solution and the second intermediate solution obtained in the step S103 undergo a third reaction process to obtain the epoxy resin monomer. In some embodiments, the third reaction process includes a third reaction temperature of 20° C. to 60° C. and a third reaction time of 1 hour to 2 hours. In some embodiments, the third reaction temperature may be 25° C. to 55° C., 30° C. to 50° C., 35° C. to 45° C., or 40° C. The epoxy equivalent weight of the epoxy resin monomer formed by the method for manufacturing the epoxy resin monomer in the present disclosure may be adjusted by modifying the third reaction temperature in the third reaction process. For example, when the third reaction temperature is within the above temperature range, the epoxy resin monomer formed by the method for manufacturing the epoxy resin monomer in the present disclosure may have an epoxy equivalent weight of 200 g/mol or less, but the present disclosure is not limited thereto. In some embodiments, the epoxy equivalent weight of the epoxy resin monomer formed by the method for manufacturing the epoxy resin monomer in the present disclosure may be increased by raising the third reaction temperature in the third reaction process.

The manufacturing method of the epoxy resin monomer, including the steps S101 to S105, involves stepwise addition of epichlorohydrin and the addition of the first and second catalysts at different stages. Accordingly, the above method for manufacturing the epoxy resin monomer may increase the production rate of the epoxy resin monomer, the production efficiency of the epoxy resin monomer, the purity of product, and/or may reduce the consumption of the epichlorohydrin in the method for manufacturing the epoxy resin monomer. A reduction in the amount of the epichlorohydrin may reduce carbon emissions and thus achieve the goal of environmental protection.

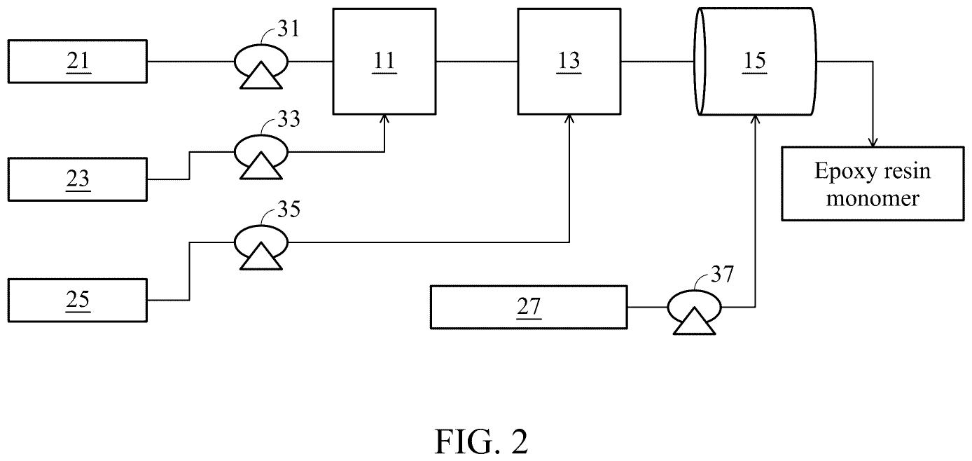

Another aspect of the present disclosure provides a system for manufacturing the epoxy resin monomer. FIG. 2 shows a schematic of a system for manufacturing epoxy resin monomer according to an embodiment of the present disclosure. As shown in FIG. 2, the system for manufacturing the epoxy resin monomer in the present disclosure includes a first micro-reactor 11, a second micro-reactor 13, and a tubular reactor 15, wherein the first micro-reactor 11 and the tubular reactor 15 are respectively in fluid communication with the second micro-reactor 13. The system for manufacturing the epoxy resin monomer in the present disclosure further includes a first reactant tank 21, a second reactant tank 23, a third reactant tank 25, and a fourth reactant tank 27. The first reactant tank 21 and the second reactant tank 23 are in fluid communication with the first micro-reactor 11 via a first delivery unit 31 and a second delivery unit 33, respectively. The third reactant tank 25 is in fluid communication with the second micro-reactor 13 via the third delivery unit 35. The fourth reactant tank 27 is in fluid communication with the tubular reactor 15 via the fourth delivery unit 37.

In some embodiments, the system for manufacturing the epoxy resin monomer disclosed herein may be used to implement the method for manufacturing the epoxy resin monomer in the present disclosure, but the present disclosure is not limited thereto. The system for manufacturing the epoxy resin monomer disclosed in the present disclosure is described below by taking the manufacturing system for implementing method for manufacturing the epoxy resin monomer disclosed in the present disclosure as an example. In this embodiment, the reactant solution is loaded in the first reactant tank 21; the first catalyst solution is loaded in the second reactant tank 23; the second catalyst solution is loaded in the third reactant tank 25; and the alkaline compound solution is loaded in the fourth reactant tank 27.

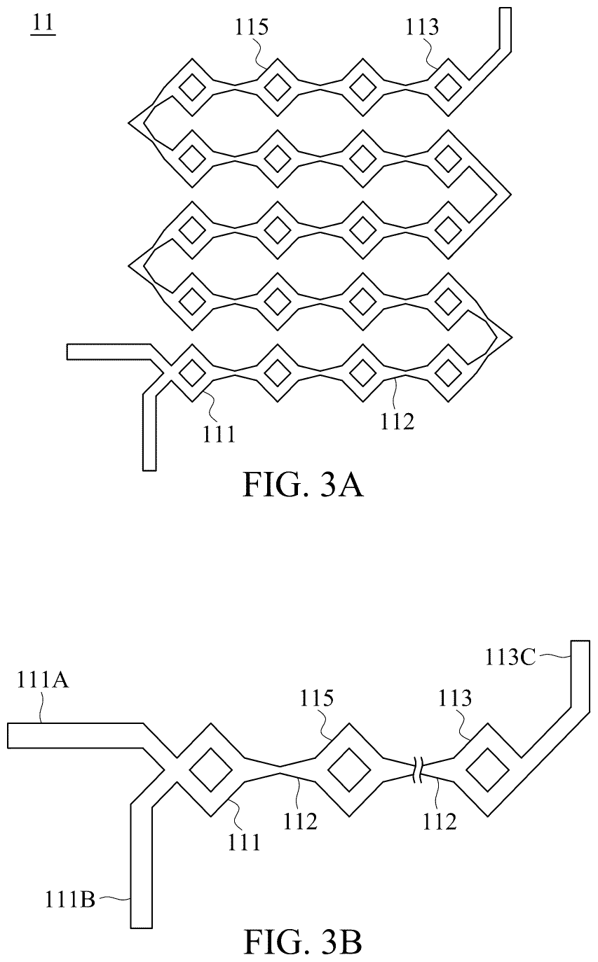

FIG. 3A shows a schematic of a first micro-reactor 11 in the system for manufacturing the epoxy resin monomer according to an embodiment of the present disclosure. FIG. 3B shows a partially enlarged schematic of the first micro-reactor 11 in the system for manufacturing the epoxy resin monomer according to an embodiment of the present disclosure.

As shown in FIG. 3A and FIG. 3B, the first micro-reactor 11 in the system for manufacturing the epoxy resin monomer of the embodiment of the present disclosure includes a first mixing element 111, a second mixing element 113 in fluid communication with the first mixing element 111, and a first jet element 112 in fluid communication with the first mixing element 111 and the second mixing element 113. The first mixing element 111 may include a first inflow channel 111A and a second inflow channel 111B. The first inflow channel 111A may be in fluid communication with the first delivery unit 31 to introduce the reactant solution in the first reactant tank 21, and the second inflow channel 111B may be in fluid communication the second delivery unit 33 to introduce the first catalyst solution in the second reactant tank 23. The second mixing element 113 may include a first outlet 113C in fluid communication with the second micro-reactor 13. The first inflow channel 111A and the second inflow channel 111B are both in fluid communication with the first jet element 112. Therefore, the reactant solution introduced from the first inflow channel 111A and the first catalyst solution introduced from the second inflow channel 111B both flow into the first jet element 112 and are mixed in the first jet element 112 to form a first intermediate solution. The first intermediate solution then flows to the second mixing element 113 in fluid communication with the first jet element 112, and may be discharged through the first outlet 113C of the second mixing element 113. That is, the reactant solution introduced from the first inflow channel 111A and the first catalyst solution introduced from the second inflow channel 111B may be mixed as passing through the first jet element 112 to form a first intermediate solution, and the first intermediate solution may be introduced into the second micro-reactor 13 through the first outlet 113C of the second mixing element 113. In some embodiments, the first micro-reactor 11 may further include other mixing element 115 disposed between the first mixing element 111 and the second mixing element 113, and the other mixing element 115 may be in fluid communication with the second mixing element 113 through the first jet element 112 and the first mixing element 111. In some embodiments, the structure of the first micro-reactor 11 may be similar to the structure of the microfluidic channel device in U.S. Pat. No. 10,537,869B1, the disclosure of which is incorporated by reference herein, but the present disclosure is not limited thereto.

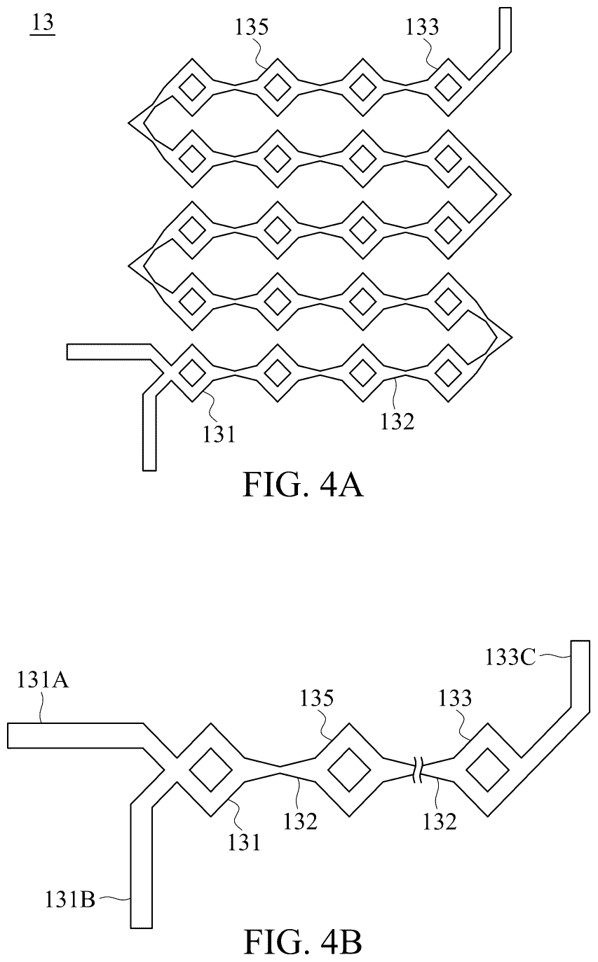

FIG. 4A shows a schematic of a second micro-reactor 13 in the system for manufacturing the epoxy resin monomer according to an embodiment of the present disclosure. FIG. 4B shows a partially enlarged schematic of the second micro-reactor 13 in the system for manufacturing the epoxy resin monomer according to an embodiment of the present disclosure.

As shown in FIG. 4A and FIG. 4B, the second micro-reactor 13 in the system for manufacturing the epoxy resin monomer of the embodiment of the present embodiment includes a third mixing element 131, a fourth mixing element 133 in fluid communication with the third mixing element 131, and a second jet element 132 in fluid communication with the third mixing element 131 and the fourth mixing element 133. The third mixing element 131 may include a third inflow channel 131A and a fourth inflow channel 131B. The third inflow channel 131A may be in fluid communication with the first outlet 113C of the second mixing element 113 to introduce the first intermediate solution, and the fourth inflow channel 131B may be in fluid communication with the third delivery unit 35 to introduce the second catalyst solution in the third reactant tank 25. The fourth mixing element 133 may include a second outlet 133C in fluid communication with the tubular reactor 15. The third inflow channel 131A and the fourth inflow channel 131B are both in fluid communication with the second jet element 132. Therefore, the first intermediate solution introduced from the third inflow channel 131A and the second catalyst solution introduced from the fourth inflow channel 131B both flow into the second jet element 132 and are mixed in the second jet element 132 to form a second intermediate solution. The second intermediate solution then flows to the fourth mixing element 133 in fluid communication with the second jet element 132, and may be discharged through the second outlet 133C of the fourth mixing element 133. That is, the first intermediate solution introduced from the third inflow channel 131A and the second catalyst solution introduced from the fourth inflow channel 131B may be mixed as passing through the second jet element 132 to form a second intermediate solution, and the second intermediate solution may be introduced into the tubular reactor 15 through the second outlet 133C of the fourth mixing element 133. In some embodiments, the second micro-reactor 13 may further include other mixing element 135 disposed between the third mixing element 131 and the fourth mixing element 133, and the other mixing element 135 may be in fluid communication with the fourth mixing element 133 through the second jet element 132 and the third mixing element 131. In some embodiments, the structure of the second micro-reactor 13 may be similar to the structure of the microfluidic channel device in U.S. Pat. No. 10,537,869B1, but the present disclosure is not limited thereto.

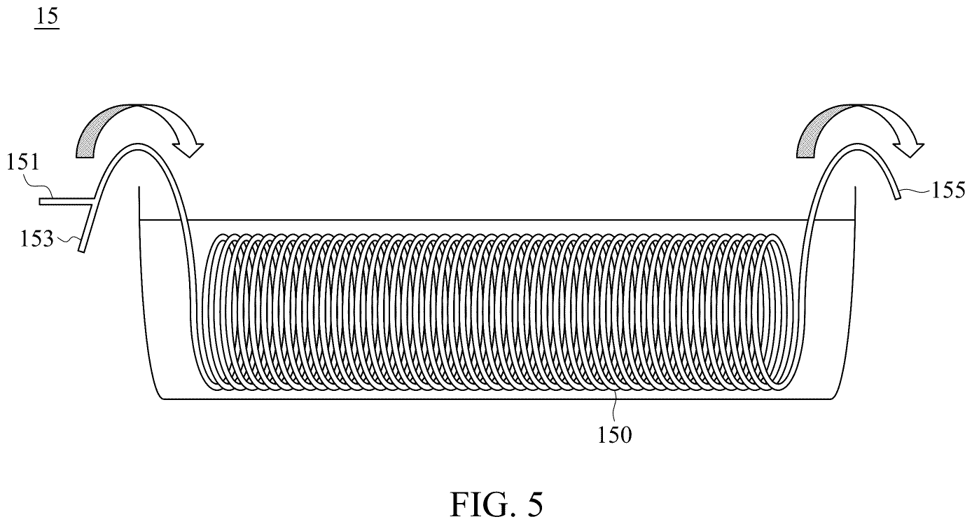

FIG. 5 shows a schematic of a tubular reactor 15 in the system for manufacturing the epoxy resin monomer according to an embodiment of the present disclosure.

As shown in FIG. 5, the tubular reactor 15 includes a main body 150 and a first inlet 151, a second inlet 153, and an outlet 155 which are in fluid communication with the main body 150. The first inlet 151 is in fluid communication with the second discharge outlet 133C of the fourth mixing element 133 in the second micro-reactor 13 to introduce the second intermediate solution into the main body 150. The second inlet 153 is in fluid communication with the fourth delivery unit 37 to introduce the alkaline compound solution in the fourth reactant tank 27 into the main body 150. The second intermediate solution reacts with the alkaline compound solution in the main body 150 to form epoxy resin monomers, and the epoxy resin monomers are subsequently discharged through the outlet 155 in fluid communication with the body 150.

The structure of the first delivery unit 31 in the present disclosure is not specifically limited, as long as it can be used to deliver the reactant solution in the first reactant tank 21 to the first micro-reactor 11. Similarly, the structures of the second delivery unit 33, the third delivery unit 35, and the fourth delivery unit 37 are also not specifically limited, as long as they can be used to deliver the first catalyst solution, the second catalyst solution, and the alkaline compound solution, respectively. In some embodiments, the flow rate ratio of the reactant solution introduced by the first delivery unit 31 to the second catalyst solution introduced by the third delivery unit 35 can be between 90:5 and 98:1 to ensure complete dissolution of the diphenol compound while maintaining the required concentration of the second catalyst solution, but the present disclosure is not limited thereto. In some embodiments, the flow rate ratio of the reactant solution introduced by the first delivery unit 31 to the second catalyst solution introduced by the third delivery unit 35 can be between 90:5 to 98:1 to ensure complete dissolution of the diphenol compound while maintaining the required concentration of second catalyst solution. Adding the catalyst solution at two stages helps gradually increase the concentration of the reaction catalyst and reduce byproducts formed by the side reactions. In some embodiments, the flow rate ratio of the first catalyst solution introduced by second delivery unit 33 to the second catalyst solution introduced by the third delivery unit 35 can be between 4:1 to 1:4.

In some embodiments, the system for manufacturing the epoxy resin monomer in the present disclosure may further include a first temperature control unit (not shown) combined with the first micro-reactor 11. The first temperature control unit may provide a reaction temperature of 50° C. to 100° C. to the first micro-reactor 11. Accordingly, the reactant solution introduced from the first inflow channel 111A and the first catalyst solution introduced from the second inflow channel 111B may undergo a first reaction process at a reaction temperature of 50° C. to 100° C. in the first micro-reactor 11 to obtain a first intermediate solution.

In some embodiments, the system for manufacturing the epoxy resin monomer in the present disclosure may further include a second temperature control unit (not shown) combined with the second micro-reactor 13. The second temperature control unit may provide a reaction temperature of 50° C. to 100° C. to the second microfluidic channel reactor 13. Accordingly, the first intermediate solution introduced from the third inflow channel 131A and the second catalyst solution introduced from the fourth inflow channel 131B may undergo a second reaction process at a reaction temperature of 50° C. to 100° C. in the second micro-reactor 13 to obtain a second intermediate solution.

In some embodiments, the system for manufacturing the epoxy resin monomer in the present disclosure may further include a third temperature control unit (not shown) combined with the tubular reactor 15. The third temperature control unit may provide a reaction temperature of 20° C. to 60° C. to the tubular reactor 15. Accordingly, the second intermediate solution introduced from the first inlet 151 and the alkaline compound solution introduced from the second inlet 153 may undergo a third reaction process at a reaction temperature of 20° C. to 60° C. in the tubular reactor 15 to obtain the epoxy resin monomer in the present disclosure.

The system for manufacturing the epoxy resin monomer in the present disclosure having the above structure may be used to implement a method for manufacturing the epoxy resin monomer that may increase the production rate of the epoxy resin monomer, the production efficiency of the epoxy resin monomer, the purity of products, and/or may reduce the consumption of epichlorohydrin in the method for manufacturing the epoxy resin monomer.

Specific embodiments are provided below to further describe the characteristics and advantages of the present disclosure. However, those skilled in the art should understand that the present disclosure is not limited to the specific embodiments disclosed below.

### Example 1

100 g of bisphenol A and 190 g of epichlorohydrin were mixed to form a reactant solution. 5 g of epichlorohydrin and 5 g of triethylamine were mixed to form a first catalyst solution. 5 g of epichlorohydrin and 5 g of triethylamine were mixed to form a second catalyst solution. 20 g of sodium hydroxide and 200 g of deionized water were mixed to form a 10% sodium hydroxide solution. The reactant solution was loaded into the first reactant tank of the system for manufacturing the epoxy resin monomer of the present embodiment, the first catalyst solution was loaded into the second reactant tank, the second catalyst solution was loaded into the third reactant tank, and the alkaline compound solution was loaded into the fourth reactant tank.

The reactant solution was introduced into the first micro-reactor via the first delivery unit, and the first catalyst solution was introduced into the first micro-reactor via the second delivery unit, wherein the flow rate ratio of the reactant solution introduced by the first delivery unit to first catalyst solution introduced by the second delivery unit was 95:2.5. The temperature of the first micro-reactor was adjusted to 60° C., and the reactant solution and the first catalyst solution were reacted at 60° C. for 1.5 hours to form a first intermediate solution, and the first intermediate solution was then delivered to the second micro-reactor.

The second catalyst solution was introduced into the second micro-reactor via the third delivery unit, wherein the flow rate ratio of reactant solution introduced by the first delivery unit to the second catalyst solution introduced by the third delivery unit was 95:2.5. The temperature of the second micro-reactor was adjusted to 60° C., and the first intermediate solution and the second catalyst solution were reacted at 60° C. for 1.5 hours to form a second intermediate solution, and the second intermediate solution was then delivered to the tubular reactor.

A 10% sodium hydroxide solution was introduced into the tubular reactor via a fourth delivery unit. The temperature of the tubular reactor was adjusted to 40° C., and the second intermediate solution was reacted with the alkaline compound at 40° C. for 1 hour to form epoxy resin monomer 1.

### Examples 2 to 5

Epoxy resin monomers 2 to 5 were formed in the same manner as in Example 1, except that the temperatures of the first micro-reactor, the second micro-reactor, and the tubular reactor were adjusted to the temperatures shown in Table 1 and the reactions were performed for the time shown in Table 1 to form epoxy resin monomers 2 to 5.

TABLE 1

| | Example 2 | Example 3 | Example 4 | Example 5 |
|---|---|---|---|---|
| First micro- | 80° C./1 h | 80° C./1 h | 60° C./1.5 h | 60° C./1.5 h |
| reactor | | | | |
| Second micro- | 60° C./1.5 h | 80° C./1 h | 60° C./1.5 h | 60° C./1.5 h |
| reactor | | | | |
| Tubular Reactor | 40° C./1 h | 40° C./1 h | 30° C./2 h | 60° C./1 h |

### Example 6

Epoxy resin monomer 6 was formed in the same manner as in Example 1, except that 10% potassium hydroxide solution was used instead of 10% sodium hydroxide solution.

### Example 7

100 g of bisphenol A and 270 g of epichlorohydrin were mixed to form a reactant solution. 5 g of epichlorohydrin and 5 g of triethylamine were mixed to form a first catalyst solution. 5 g of epichlorohydrin and 5 g of triethylamine were mixed to form a second catalyst solution. 20 g of sodium hydroxide and 200 g of deionized water were mixed to form a 10% sodium hydroxide solution. The reactant solution was loaded into the first reactant tank of the epoxy resin monomer manufacturing system of the embodiment of the present disclosure, the first catalyst solution was loaded into the second reactant tank, the second catalyst solution was loaded into the third reactant tank, and the alkaline compound solution was loaded into the fourth reactant tank.

The reactant solution was introduced into the first micro-reactor via the first delivery unit, and the first catalyst solution was introduced into the first micro-reactor via the second delivery unit, wherein the flow rate ratio of the reactant solution introduced by the first delivery unit to first catalyst solution introduced by the second delivery unit introducing the was 95:2.5. The temperature of the first micro-reactor was adjusted to 60° C., and the reactant solution and the first catalyst solution were reacted at 60° C. for 1.5 hours to form a first intermediate solution, and the first intermediate solution was then delivered to the second micro-reactor.

The second catalyst solution was introduced into the second micro-reactor via the third delivery unit, wherein the flow rate ratio of the reactant solution introduced by the first delivery unit to the second catalyst solution introduced by the third delivery unit was 95:2.5. The temperature of the second micro-reactor was adjusted to 60° C., and the first intermediate solution and the second catalyst solution were reacted at 60° C. for 1.5 hours to form a second intermediate solution, and the second intermediate solution was then delivered to the tubular reactor.

A 10% sodium hydroxide solution was introduced into the tubular reactor via a fourth delivery unit. The temperature of the tubular reactor was adjusted to 60° C., and the second intermediate solution was reacted with the alkaline compound at 60° C. for 1 hour to form epoxy resin monomer 7.

### Comparative Examples 1 to 4

### Comparative Example 1

100 g of bisphenol A and 190 g of epichlorohydrin were mixed to form a reactant solution. 10 g of epichlorohydrin and 10 g of triethylamine were mixed to form a first catalyst solution. 20 g of sodium hydroxide and 200 g of deionized water were mixed to form a 10% sodium hydroxide solution. The reactant solution was loaded in the first reactant tank of the epoxy resin monomer manufacturing system of the embodiment of the present disclosure, the first catalyst solution was loaded in the second reactant tank, and the alkaline compound solution was loaded in the fourth reactant tank.

The reactant solution was introduced into the first micro-reactor via the first delivery unit, and the first catalyst solution was introduced into the first micro-reactor via the second delivery unit, wherein the flow rate ratio of the reactant solution introduced by the first delivery unit to the first catalyst solution introduced by the second delivery unit was 95:5. The temperature of the first micro-reactor was adjusted to 60° C., and the reactant solution and the first catalyst solution were reacted at 60° C. for 3 hours to form a first intermediate solution, and the first intermediate solution was then delivered to the tubular reactor.

A 10% sodium hydroxide solution was introduced into the tubular reactor via a fourth delivery unit. The temperature of the tubular reactor was adjusted to 40° C., and the second intermediate solution was reacted with the alkaline compound at 40° C. for 1 hour to form a comparative epoxy resin monomer 1.

### Comparative Example 2

100 g of bisphenol A, 200 g of epichlorohydrin, and 10 g of triethylamine were mixed to form a reactant solution. The reactant solution was stirred at 60° C. for 3 hours. 20 g of sodium hydroxide and 200 g of deionized water were mixed to form a 10% sodium hydroxide solution. After 10% sodium hydroxide solution was slowly added to the reactant solution, it was then stirred and reacted at 40° C. for 1 hour to form comparative epoxy resin monomer 2.

### Comparative Example 3

100 g of bisphenol A, 280 g of epichlorohydrin, and 10 g of triethylamine were mixed to form a reactant solution. The reaction solution was stirred at 60° C. for 3 hours. 20 g of sodium hydroxide and 200 g of deionized water were mixed to form a 10% sodium hydroxide solution. 10% sodium hydroxide solution was slowly added into the reactant solution, and then stirred and reacted at 40° C. for 1 hour to form a comparative epoxy resin monomer 3.

### Evaluation of Properties of Epoxy Resin Monomers and Comparative Epoxy Resin Monomers

### <Measurement of Epoxy Equivalent Weight>

The epoxy resin equivalent weights of epoxy resin monomers 1 and 7 and comparative epoxy resin monomers 1 to 3 were measured by potentiometric titration. The measurement results are shown in Table 2 below.

TABLE 2

| | Epoxy equivalent weight |
|---|---|
| | (g/mol) |
| Epoxy Resin Monomer 1 | 180 |
| Epoxy Resin Monomer 7 | 179 |
| Comparative Epoxy Resin Monomer 1 | 186 |
| Comparative Epoxy Resin Monomer 2 | 187 |
| Comparative Epoxy Resin Monomer 3 | 186 |

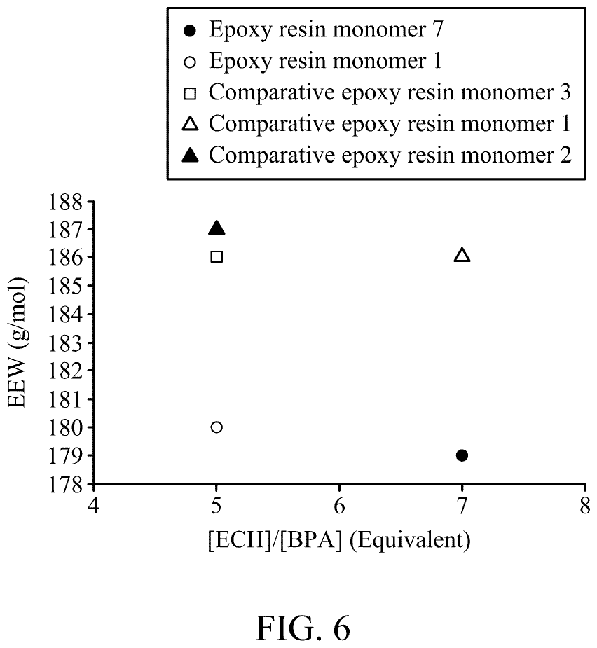

FIG. 6 shows a graph of the relationship between an epoxy equivalent weight and an equivalent of epichlorohydrin/an equivalent of diphenol compound. As it can be seen from the epoxy resin monomer 1 and the epoxy resin monomer 7 in FIG. 6, the higher the value of epichlorohydrin equivalent/diphenol compound equivalent, the smaller the epoxy equivalent weight in the epoxy resin monomer. That is, during the manufacturing of the epoxy resin monomer, the higher the consumption of epichlorohydrin, the smaller the epoxy equivalent weight in the epoxy resin monomer. From the comparative epoxy resin monomers 1 and 2 and the epoxy resin monomer 1, and the comparative epoxy resin monomer 3 and the epoxy resin monomer 2 in FIG. 6, it can be seen that the method for manufacturing the epoxy resin monomer of the embodiment of the present disclosure may obtain the epoxy resin monomer with the required epoxy equivalent via a lower value of epichlorohydrin equivalent/diphenol compound equivalent (i.e. lower consumption of epichlorohydrin). That is, the method for manufacturing the epoxy resin monomer of the embodiment of the present disclosure may manufacture the epoxy resin monomer with the required epoxy equivalent weight via the lower consumption of epichlorohydrin.

### <Measurement of Conversion Rate of Bisphenol A>

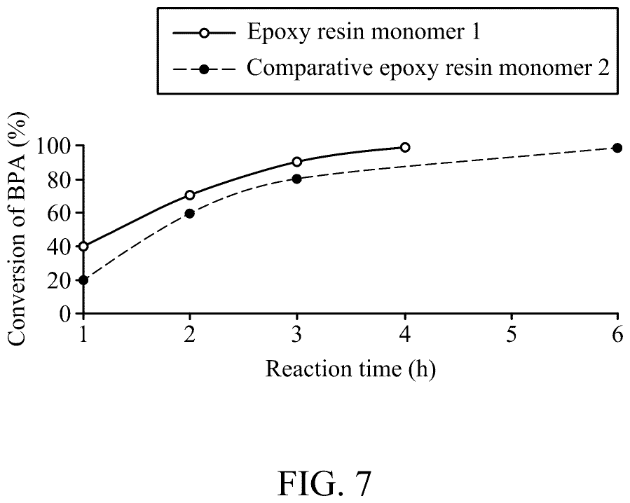

The changes in the conversion rate of bisphenol A of the epoxy resin monomer 1 and the comparative epoxy resin monomer 2 over time were measured using a liquid chromatograph with a mobile phase of n-hexane and ethyl acetate (volume ratio 2:1) and a detection wavelength of 254 nm, and the measurement results are shown in FIG. 7. FIG. 7 shows a graph of the relationship between a conversion rate of bisphenol A and a reaction time in the method for manufacturing the epoxy resin monomer according to an embodiment of the present disclosure.

It can be clearly seen from FIG. 7 that the preparation of epoxy resin monomer 1 only took about 3 hours to reach a bisphenol A conversion rate of about 90%. In contrast, the preparation of comparative epoxy resin monomer 2 required about 4.5 hours to reach about 90% conversion rate of bisphenol A. That is, the preparation time of the epoxy resin monomer 1 is about ⅔ of the preparation time of the comparative epoxy resin monomer 2. Accordingly, the method for manufacturing the epoxy resin monomer according to the embodiment of the present disclosure may increase the production rate of the epoxy resin monomer and/or the production efficiency of the epoxy resin monomer.

In summary, the manufacturing method and manufacturing system of the epoxy resin monomer in the present disclosure may increase the manufacturing rate of the epoxy resin monomer, the production efficiency of the epoxy resin monomer, the purity of the product, and/or may reduce the consumption of epichlorohydrin.

Although the embodiments and advantages of the present disclosure have been disclosed above, it should be understood that anyone with ordinary knowledge in the art can make changes, substitutions and modifications without departing from the spirit and scope of the present disclosure. In addition, the scope of protection of the present disclosure is not limited to the processes, machines, manufactures, material compositions, devices, methods and steps in the specific embodiments described in the specification, and any person with ordinary knowledge in the relevant technical field can understand the current or future developed processes, machines, manufactures, material compositions, devices, methods and steps from the disclosure of some embodiments of the present disclosure, and as long as substantially the same functions can be implemented or substantially the same results can be obtained in the embodiments described here, they can be used according to some embodiments of the present disclosure. Therefore, the protection scope of the present disclosure includes the above-mentioned processes, machines, manufacture, material compositions, devices, methods and steps. In addition, each claim constitutes a separate embodiment, and the scope of protection of the present disclosure also includes the combination of each claim and embodiment.

What is claimed is:

1. A manufacturing method for an epoxy resin monomer, comprising:
mixing a reactant solution and a first catalyst solution to obtain a first intermediate solution;
adding a second catalyst solution to the first intermediate solution to obtain a second intermediate solution; and
adding an alkaline compound solution to the second intermediate solution to obtain the epoxy resin monomer, wherein the reactant solution comprises diphenol compound and epichlorohydrin.

2. The manufacturing method of claim 1, wherein an equivalent ratio of the diphenol compound to the epichlorohydrin is 1:4.7 to 1:6.7, and the diphenol compound is bisphenol A, bisphenol F, bisphenol S, or a combination thereof.

3. The manufacturing method of claim 1, wherein the first catalyst solution comprises a first catalyst and epichlorohydrin, and the weight ratio of epichlorohydrin in the reactant solution to epichlorohydrin in the first catalyst solution is 90:5 to 98:1.

4. The manufacturing method of claim 1, wherein the first catalyst solution comprises a first catalyst and epichlorohydrin, and the first catalyst is a tertiary amine compound.

5. The manufacturing method of claim 4, wherein the tertiary amine compound is triethylamine, tripropylamine, tributylamine, or a combination thereof.

6. The manufacturing method of claim 1, wherein the second catalyst solution comprises a second catalyst and epichlorohydrin, and the second catalyst is a tertiary amine compound.

7. The manufacturing method of claim 6, wherein the tertiary amine compound is triethylamine, tripropylamine, tributylamine, or a combination thereof.

8. The manufacturing method of claim 1, wherein the alkaline compound solution comprises an alkaline compound, a concentration of the alkaline compound in the alkaline compound solution is 10 wt % to 20 wt %, and the alkaline compound is sodium hydroxide, potassium hydroxide, sodium carbonate, potassium carbonate, or a combination thereof.

9. The manufacturing method of claim 1, wherein the first catalyst solution comprises a first catalyst and epichlorohydrin, the second catalyst solution comprises a second catalyst and epichlorohydrin, and a total equivalent of the epichlorohydrin in the reactant solution, the first catalyst solution, and the second catalyst solution to an equivalent of the diphenol compound is 7:1 to 5:1.

10. A manufacturing system for an epoxy resin monomer, comprising:
a first micro-reactor;
a second micro-reactor in fluid communication with the first micro-reactor;
a tubular reactor in fluid communication with the second micro-reactor;
a first reactant tank in fluid communication with the first micro-reactor via a first delivery unit;
a second reactant tank in fluid communication with the first micro-reactor via a second delivery unit;
a third reactant tank in fluid communication with the second micro-reactor via a third delivery unit; and
a fourth reactant tank in fluid communication with the tubular reactor via a fourth delivery unit.

11. The manufacturing system of claim 10, wherein the first micro-reactor comprises:
a first mixing element;
a second mixing element, in fluid communication with the first mixing element and comprising a first discharge outlet in fluid communication with the second micro-reactor; and
a first jet element, in fluid communication with the first mixing element and the second mixing element, wherein the first mixing element comprises:
a first inflow channel, in fluid communication with the first delivery unit to introduce a first solution in the first reactant tank; and
a second inflow channel, in fluid communication with the second delivery unit to introduce a second solution in the second reactant tank, wherein the first solution and the second solution are mixed as passing through the first jet element, and a first intermediate solution is discharged through the first discharge outlet of the second mixing element.

12. The manufacturing system of claim 11, wherein the second micro-reactor comprises:
a third mixing element;
a fourth mixing element in fluid communication with the third mixing element and comprising a second discharge outlet in fluid communication with the tubular reactor; and
a second jet element in fluid communication with the third mixing element and the fourth mixing element, wherein the third mixing element comprises:
a third inflow channel in fluid communication with the first discharge outlet to introduce the first intermediate solution; and
a fourth inflow channel in fluid communication with the third delivery unit to introduce a third solution in the third reactant tank, wherein the first intermediate solution and the third solution are mixed as passing through the second jet element, and a second intermediate solution is discharged through the second outlet of the fourth mixing element.

13. The manufacturing system of claim 12, wherein the tubular reactor comprises:
a main body;
a first inlet in fluid communication with the second discharge outlet and the main body;
a second inlet in fluid communication with the fourth delivery unit and the main body; and
an outlet in fluid communication with the main body.

14. The manufacturing system of claim 10, further comprising a first temperature control unit combined with the first micro-reactor.

15. The manufacturing system of claim 10, further comprising a second temperature control unit combined with the second micro-reactor.

16. The manufacturing system of claim 10, further comprising a third temperature control unit combined with the tubular reactor.
